(19) United States
(12) Patent Application Publication
(10) Pub. No.: US 2025/0213332 A1
(43) Pub. Date: Jul. 3, 2025

(54) MAXILLOMANDIBULAR REGISTRATION TRAY

(71) Applicants: Daniel MIN, Englewood Cliff, NJ (US); Steinfeld, Inc., Seoul (KR)

(72) Inventors: Daniel MIN, Englewood Cliff, NJ (US); Ji Hyun LEE, Seoul (KR)

(21) Appl. No.: 19/002,913

(22) Filed: Dec. 27, 2024

(30) Foreign Application Priority Data
Dec. 27, 2023 (KR) 10-2023-0192548

(51) Int. Cl. A61C 9/00

(52) U.S. Cl. CPC A61C 9/0006; A61C 9/002

(57) ABSTRACT

A maxillomandibular registration tray of the present invention includes a maxillary portion that can be fixed by adding material to the maxillary portion of a patient, a mandibular portion that can be fixed by adding material to the mandibular portion of a patient, and connecting portions that connect the inner surface of the maxillary portion and the inner surface of the mandibular portion to each other. The distance between the maxillary portion and mandibular portion is adjustable after separating the maxillary portion and mandibular portion. Therefore, the maxillomandibular registration tray first applies materials to the maxillary portion and mandibular portion to acquire maxillomandibular registration, and then separates the maxillary portion and mandibular portion to adjust the distance using screws to set the vertical height, establish the mandibular position, and add bite registration materials to the maxillary and mandibular tray space to finally acquire precise maxillomandibular registration.

### CROSS-REFERENCE TO RELATED APPLICATIONS

This patent application claims priority to Korean Patent Application No. 10-2023-0192548, filed Dec. 27, 2023 and the entire contents of which are incorporated herein by reference.

### TECHNICAL FIELD

The present invention relates to a maxillomandibular registration tray used in fabricating dentures for edentulous patients. This single tray allows simultaneous registration of the maxillomandibular relationship through the addition of materials. By separating the maxillary and mandibular portions of the tray and adjusting the distance between them as desired, the vertical dimension and mandibular position can be determined. The final maxillomandibular registration is completed by adding materials to the maxillomandibular space, enabling precise registration in a single patient visit and significantly reducing the time required for denture fabrication.

### BACKGROUND

The conventional process for fabricating dentures for edentulous patients involved multiple steps: creating a preliminary model from diagnostic or treatment impressions, fabricating a custom tray for accurate impression taking, producing a master model after the custom tray fabrication, creating a record base and occlusal rim, adjusting the articulator with the occlusal rim, and arranging artificial teeth. This conventional process required three to five dental visits and was time-consuming. To address this, a tray was developed that could capture the maxillomandibular relationship simultaneously by applying impression material to both maxillary and mandibular arches without using a wax rim. However, this tray presented technical challenges as it required patients to close their mouth to a predetermined vertical dimension while simultaneously guiding the horizontal jaw relationship (centric relation). If patients closed their mouth either too much or too little relative to the predetermined vertical dimension, the entire occlusal registration process had to be repeated, resulting in unnecessary time consumption.

Additionally, a Gothic arch tracing device composed of a plate and pin enables adjustment of the vertical dimension through screw height modification and allows for precise recording of the horizontal jaw relationship (centric relation). However, there are two methods for applying the Gothic arch tracing: one involves fabricating it on an impression model, which requires an additional patient visit; the other involves recording the maxillomandibular relationship on the day of impression taking by applying impression material to both maxillary and mandibular arches to secure the Gothic arch device. However, this latter method is time-consuming when applied to each arch separately and presents difficulties in adjusting both the screw length and the interocclusal registration space.

Consequently, there existed a need for a novel maxillomandibular registration tray that could reduce the number of patient visits, decrease lengthy treatment times, and achieve precise maxillomandibular registration efficiently.

### SUMMARY OF THE INVENTION

The present invention aims to provide a maxillomandibular registration tray featuring attached and combined maxillary and mandibular portions with Gothic arch tracings. The tray enables initial maxillomandibular registration by simultaneously applying materials to both the maxillary and mandibular portions. Following this, the combined portions are separated, and screws are inserted to precisely adjust the vertical separation distance between them, thereby controlling the vertical occlusal height. Precise intermaxillary relationship can be rapidly obtained by applying bite registration materials to the tray spaces of both the maxillary and mandibular portions.

To address the challenges described above, a tray for maxillomandibular registration according to one embodiment of the present invention includes a maxillary portion that can contact the patient's maxilla, a mandibular portion that can contact the patient's mandible, and a tray for maxillomandibular registration including connecting portions between the inner surface of the maxillary portion and the inner surface of the mandibular portion. The separation distance between the maxillary portion and the mandibular portion is adjustable.

Specific details of other embodiments are included in the detailed description and drawings.

According to the present invention, the following various effects are achieved.

The present invention can effectively reduce the number of dental visits a patient needs to make for dentures.

The present invention enables the simultaneous maxillomandibular registration of the maxillary portion and mandibular portion by simultaneously adding materials to the maxillary and mandibular portions that are bonded to each other. Subsequently, the occlusal height can be adjusted using a screw to quickly acquire a precise intermaxillary relationship.

The effects of the present invention are not limited to the examples given above; many more are included within this specification and are suggested by other exemplary embodiments described in the detailed description and drawings.

### BRIEF DESCRIPTION OF FIGURES

FIGS. 1 to 4 illustrate a tray for maxillomandibular registration according to embodiment of the present invention.

FIG. 5 illustrates a screw for adjusting the distance of a tray for maxillomandibular registration according to embodiment of the present invention.

FIGS. 6A to 6C illustrate a tray for maxillomandibular registration according to embodiment of the present invention.

FIG. 7 illustrates a tray for maxillomandibular registration according to another embodiment of the present invention.

FIG. 8 illustrates a tray for maxillomandibular registration according to another embodiment of the present invention.

FIG. 9 illustrates a tray for maxillomandibular registration according to another embodiment of the present invention.

FIG. 10 illustrates a tray for maxillomandibular registration according to another embodiment of the present invention.

### DETAILED DESCRIPTION OF INVENTION

Various embodiments of the present invention will now be described in detail with reference to the accompanying drawings. The advantages and features of the present invention, and methods of achieving them, will become apparent by referring to the embodiments described in detail with reference to the accompanying drawings. However, the invention is not limited to the disclosed embodiments and may be embodied in many different forms. These embodiments are provided merely to make the disclosure of the invention complete and to give those of ordinary skill in the art a full understanding of the scope of the invention, which is defined by the claims.

The shapes, sizes, proportions, angles, numbers, etc., disclosed in the drawings to illustrate embodiments of the present invention are exemplary and do not limit the invention to those shown. Throughout the specification, like reference numerals refer to like components. Additionally, in describing the invention, detailed descriptions of related known art are omitted where such descriptions would unnecessarily obscure the essence of the invention. Wherever the words “comprise”, “includes,” “has,” “consists of,” and the like are used in this specification, other parts may be added unless “only” is used. Whenever a component is expressed in the singular, it includes the plural unless otherwise expressly stated.

Components are interpreted to include a margin of error, even if not explicitly stated otherwise.

If the description refers to a positional relationship between two parts, for example, “on top of,” “above,” “below,” “next to,” etc., one or more other parts may be located between the two parts unless “directly” or “immediately” is used.

When an element or layer is referred to as being “on” another element or layer, this includes any intervening layer or other element directly on top of or between the other elements.

Although terms like first, second, and so on are used to describe various components, these components are not limited by these terms. Such terms are used only to distinguish one component from another. Therefore, a first component may also be referred to as a second component within the technical scope of the present invention.

Throughout the specification, the same reference numerals refer to the same components.

The size and thickness of each component shown in the drawings are shown for illustrative purposes only, and the invention is not limited to the size and thickness shown.

Each feature of the various embodiments of the present invention can be combined or integrated with each other, in part or in whole, as will be fully appreciated by those skilled in the art. Various technical interlockings and operations are possible, and each embodiment can be practiced independently or together in combination.

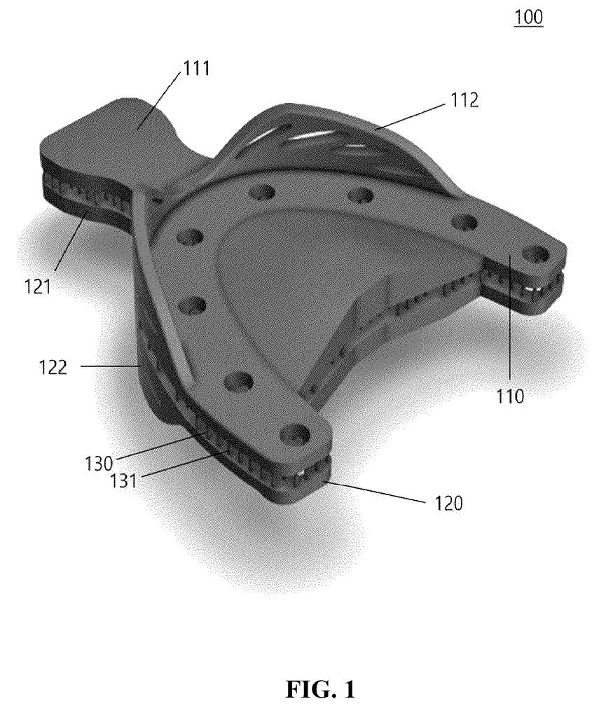

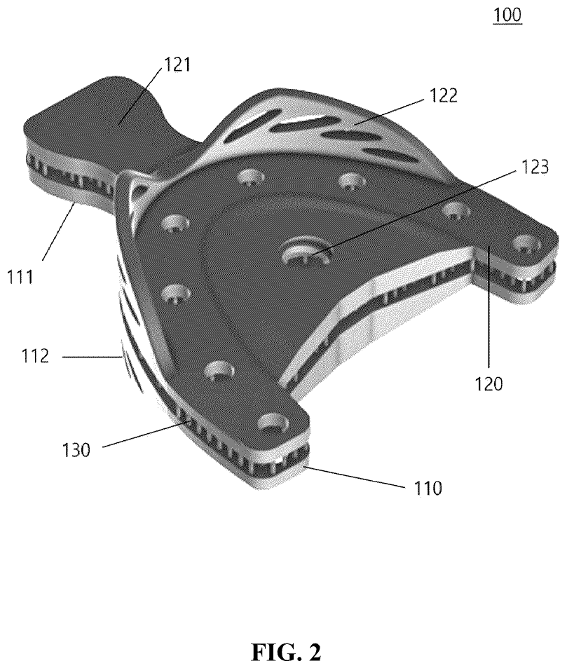

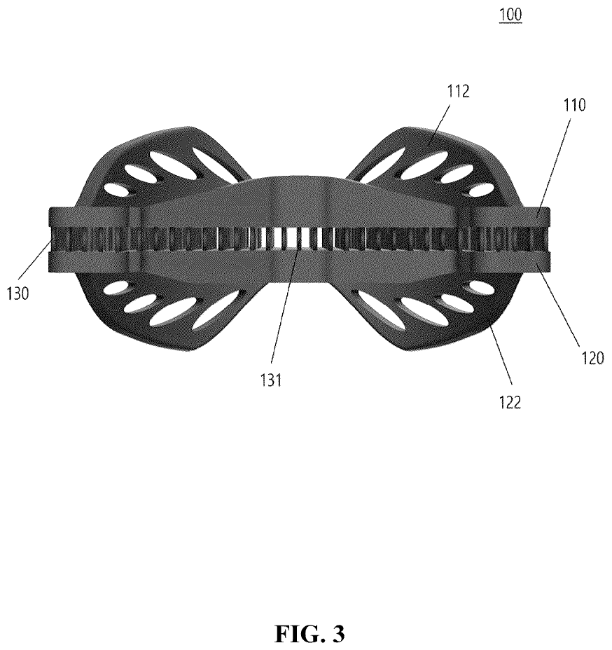

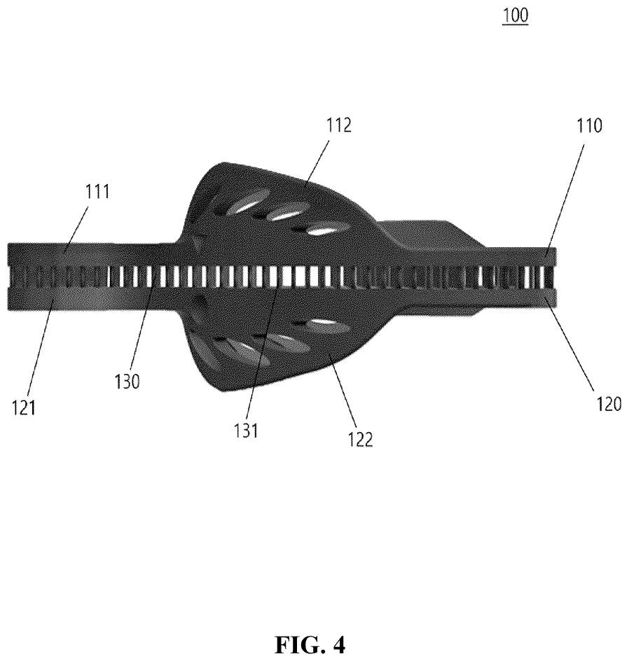

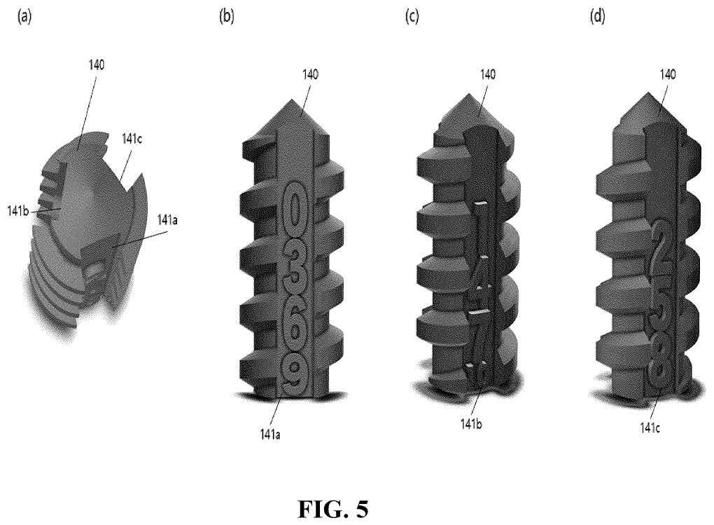

FIGS. 1 to 4 illustrate a tray for maxillomandibular registration according to embodiment of the present invention. FIG. 5 illustrates an adjustable distance screw of a tray for maxillomandibular registration according to embodiment of the present invention.

Referring to FIGS. 1 to 5, the maxillomandibular registration tray 100 is designed to simultaneously and precisely record the maxillomandibular relationship of edentulous patients by applying impression material for denture fabrication. The maxillomandibular registration tray 100 can be manufactured using a 3D printer, though this is not the only manufacturing method. The maxillomandibular registration tray 100 may comprise a maxillary portion 110, a mandibular portion 120, connecting portions 130, and a distance adjustment screw 140.

The maxillary portion 110 of the tray 100 is designed to be positioned against the patient's maxillary arch when the tray is inserted into the oral cavity. The maxillary portion 110 incorporates a handle 111 enabling the operator to manually guide the tray 100 into the patient's mouth. The end of the maxillary portion 110 opposite to where the handle 111 is located serves as the intraoral insertion end. The maxillary portion 110 features a stopper 112 that prevents excessive insertion by limiting the depth of intraoral penetration to an appropriate level. This stopper 112 extends perpendicular to the longitudinal axis of the maxillary portion 110 and is designed to rest between the maxillary vestibule and upper lip when the maxillary portion 110 is properly positioned in the oral cavity.

The mandibular portion 120 of the tray 100 is designed to be positioned against the patient's mandibular arch when the tray is inserted into the oral cavity. It incorporates a handle 121 that corresponds to the maxillary handle 111, allowing the operator to manipulate the tray 100). This configuration enables the operator to simultaneously grasp both handles 111 and 121 when inserting the tray 100. The end of the mandibular portion 120 opposite to the handle 121 serves as the intraoral insertion end. This insertion end of the mandibular portion 120 and the previously described insertion end of the maxillary portion 110 are designed as corresponding parts that face each other. The mandibular portion 120 features a stopper 122 that prevents excessive insertion by limiting the depth of intraoral penetration to an appropriate level. This stopper 122 extends perpendicular to the longitudinal axis of the mandibular portion 120 and is designed to rest between the mandibular vestibule and lower lip when the tray is properly positioned in the oral cavity.

A screw hole 123 for the distance adjustment screw 140 may be formed in the central portion of the mandibular portion 120. The screw hole 123 may be formed perpendicular to the longitudinal axis of the mandibular portion 120, penetrating through its central portion to accommodate the distance adjustment screw 140 as described below. While FIGS. 1 to 4 illustrate the screw hole 123 in the mandibular portion 120, the screw hole 123 may alternatively be located in the central portion of the maxillary portion 110. In other words, the screw hole 123 may be positioned in either the maxillary portion 110 or the mandibular portion 120. When the screw hole 123 is formed in the maxillary portion 110, the distance adjustment screw 140, to be described later, can pass through this screw hole 123 to exert pressure on the inner surface of the mandibular portion 120.

Connecting portions 130 may be positioned between the maxillary portion 110 and mandibular portion 120 of the tray 100. These connecting portions 130 are designed to maintain a minimum separation distance between the maxillary portion 110 and mandibular portion 120. Specifically, the connecting portions 130 join the inner surfaces of both the maxillary portion 110 and mandibular portion 120. While the outer surfaces of the maxillary portion 110 and mandibular portion 120 correspond to the patient's maxillary and mandibular arches respectively, their inner surfaces face each other and are joined by the connecting portions 130.

The connecting portions 130 serve to join the maxillary portion 110 and mandibular portion 120. According to one embodiment, as illustrated in FIGS. 1 to 4, the connecting portions 130 may comprise multiple posts 131. These posts 131 extend perpendicular to the longitudinal axis of both the maxillary and mandibular portions 110 and 120, connecting their inner surfaces. The posts 131 function to maintain the structural integrity of the tray 100 by ensuring that the separation distance between the maxillary and mandibular portions 110 and 120 cannot become less than the length of the posts 131. Specifically, when the tray 100 is inserted into the patient's oral cavity for maxillomandibular registration, these posts 131 serve as structural supports, preventing the separation distance between the maxillary and mandibular portions 110 and 120 from becoming less than the posts' length.

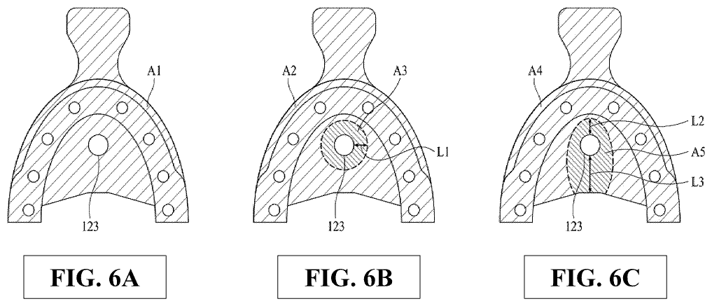

Referring to FIG. 6A, the posts 131 of the connecting portions 130 may be distributed throughout the first region A1, which encompasses the entire inner surfaces of both the maxillary portion 110 and mandibular portion 120. This comprehensive distribution of posts across the entire inner surfaces ensures that the separation distance between the maxillary and mandibular portions 110 and 120 is maintained even when the operator grips the handles or when the patient applies occlusal force to the tray 100.

According to one embodiment of the present invention, the tray 100 may be manufactured using a 3D printer. Specifically, the tray's design incorporating connecting portions 130 with multiple posts 131 between the maxillary portion 110 and mandibular portion 120 can be fabricated more efficiently and with higher precision using 3D printing technology. However, the manufacturing process is not limited to 3D printing; the tray 100 can also be produced through various other manufacturing methods, such as injection molding, according to the manufacturer's requirements.

According to one embodiment, the distribution of posts 131 within the connecting portions 130 is not restricted to the first region A1, which encompasses the entire inner surfaces of both the maxillary portion 110 and mandibular portion 120, as illustrated in FIG. 6A.

According to another embodiment, as illustrated in FIG. 6B, the posts 131 of the connecting portions 130 may be positioned only in areas not adjacent to the screw hole 123. Specifically, the inner surfaces of both the maxillary portion 110 and mandibular portion 120 comprise two distinct regions: the third region A3, which is adjacent to the screw hole 123, and the second region A2, which encompasses the remaining area excluding the third region A3. As shown in FIG. 6B, the third region A3 is configured as a circular area centered around the screw hole 123, with a clearance of the first distance L1 from the screw hole 123. While the third region A3, which contains no posts 131, is depicted as circular in FIG. 6B, it is not limited to this shape; it may be designed as square or elliptical, and its configuration can be modified according to manufacturing specifications.

According to another embodiment, as illustrated in FIG. 6C, the posts 131 of the connecting portions 130 may be positioned only in the fourth region A4, excluding the fifth region A5 which is adjacent to the screw hole 123. The fifth region A5 extends to the edges of both the maxillary portion 110 and mandibular portion 120 that are opposite to the handle portion 111 of the tray 100. Specifically, as shown in FIG. 6C, the fifth region A5 is configured as a partial elliptical area incorporating the screw hole 123, extending bidirectionally through the handle portion 111 with the screw hole 123 as its center point. The second distance L2, measured from the screw hole 123 to the periphery of the fifth region A5 in the direction of the handle portion 111, is designed to be shorter than the third distance L3, measured from the screw hole 123 to the periphery of the fifth region A5 in the direction opposite to the handle portion 111. In comparison to the third region A3 shown in FIG. 6B, the fifth region A5 extends further toward the edge of the mandibular portion 120 on the side opposite to the handle portion 111. While the fifth region A5, which contains no posts 131, is depicted as elliptical in FIG. 6C, it is not limited to this shape and may be configured in other forms such as rectangular, subject to design modifications.

If the plurality of posts 131 are not disposed in a region (third region A3 or fifth region A5) adjacent to the screw holes 123 as shown in FIGS. 6B and 6C, the convenience of a user performing the gothic arch tracing required to fabricate the denture may be further increased. Specifically, if the plurality of posts 131 are not disposed in the third region A3 adjacent to the screw holes 123, the user's accessibility to the screw holes 123 and the adjacent region may be facilitated. Furthermore, when the plurality of posts 131 are not disposed up to a first edge of the maxillary portion 110 and the mandibular portion 120, such as in the fifth region A5, a path from the screw holes 123 to the first edge of the maxillary portion 110 and the mandibular portion 120 is secured, which has the effect of increasing the convenience of the user in performing the Gothic arch tracing.

According to one embodiment, the plurality of posts 131 may be distributed on the inner surface of the maxillary portion 110 and the inner surface of the mandibular portion 120 in a grid-like manner, and the spacing between adjacent posts 131 may be 2 mm to 4 mm. If the spacing between adjacent posts 131 is less than 2 mm, the number of posts 131 increases such that the maxillary portion 110 and the mandibular portion 120 may not be easily separated by an external force (typical human force). Furthermore, if the spacing between adjacent posts 131 is greater than 4 mm, when the tray 100 is bitten by a patient, the plurality of posts 131 may not withstand the pressure and may bend, causing the distance between the maxillary portion 110 and the mandibular portion 120 to decrease without being maintained.

The distance adjustment screw 140 of the tray 100 is configured to adjust the separation distance between the maxillary portion 110 and the mandibular portion 120. The user of the tray 100 can introduce the distance adjustment screw 140 toward the inner surface of the maxillary portion 110 through the screw hole 123 formed in the mandibular portion 120. The surface shape of the screw hole 123 may correspond to the threads and grooves of the distance adjustment screw 140. Accordingly, when the distance adjustment screw 140 is inserted into the screw hole 123, it can be advanced toward or retracted from the inner surface of the maxillary portion 110 through the screw hole 123 by rotation around its axis.

The distance adjustment screw 140, which is introduced through the screw hole 123 of the mandibular portion 120 toward the inner surface of the maxillary portion 110, may contact the inner surface of the maxillary portion 110. When the user further advances the distance adjustment screw 140, it may exert pressure on the maxillary portion 110 in a direction away from the mandibular portion 120. The pressure exerted by the distance adjustment screw 140 on the inner surface of the maxillary portion 110 may increase the separation distance between the maxillary portion 110 and the mandibular portion 120.

In this case, the separation distance between the maxillary portion 110 and the mandibular portion 120 can be adjusted according to the distance the distance adjustment screw 140 is introduced into the screw hole 123. Specifically, if the distance adjustment screw 140 is inserted 1 mm through the screw hole 123 while one end of the screw 140 is in contact with the inner surface of the maxillary portion 110, the separation distance between the maxillary portion 110 and the mandibular portion 120 can increase by 1 mm beyond the length of the plurality of posts 131. Therefore, the insertion distance of the distance adjustment screw 140 through the screw hole 123 beyond the length of the plurality of posts 131 corresponds to the additional separation distance between the maxillary portion 110 and the mandibular portion 120.

Referring to FIG. 5, the distance adjustment screw 140 of the tray 100 may include one or more numerical markings 141 on its surface. Specifically, the surface of the distance adjustment screw 140 may have one or more numerical markings 141 extending in the lengthwise direction of the screw, and as shown in FIG. 5, there may be three numerical markings 141. The numerical markings 141 can display numbers indicating the extent to which the distance adjustment screw 140 is inserted through the screw hole 123, that is, the length by which the distance adjustment screw 140 is inserted beyond both its contact with the inner surface of the maxillary portion 110 and the length of the plurality of posts 131. The user can insert the distance adjustment screw 140 to a desired length using the numerical markings 141, thereby precisely controlling the separation distance between the maxillary portion 110 and the mandibular portion 120.

The number of numerical markings 141 on the distance adjustment screw 140 may correspond to the distance between adjacent threads of the screw 140 divided by a reference distance. The distance between threads refers to the distance by which the distance adjustment screw 140 advances into the screw hole 123 when rotated one full turn. The reference distance is the smallest unit of adjustable insertion length, or in other words, the smallest adjustable unit of separation distance between the maxillary portion 110 and the mandibular portion 120 that can be achieved by turning the screw 140 through the screw hole 123. For example, as shown in FIG. 5, if the distance between threads is 3 mm, one full turn of the distance adjustment screw 140 will advance it 3 mm through the screw hole 123. If the reference distance is set to 1 mm, the number of numerical markings 141 will be three, corresponding to the 3 mm distance between threads divided by the 1 mm reference distance. The numerical markings 141 are evenly spaced along the surface of the distance adjustment screw 140. Thus, when the user turns the distance adjustment screw 140 from one numerical marking 141 to the adjacent marking, the screw 140 advances through the screw hole 123 by the reference distance (1 mm), thereby increasing the separation distance between the maxillary portion 110 and the mandibular portion 120 by the reference distance (1 mm). The distance between threads and reference distance are not limited to the above example and can be modified according to user requirements.

The numerical markings 141 may display numbers along the length of the distance adjustment screw 140. When a user adjusts the distance adjustment screw 140 by rotating it and advancing it through the screw hole 123 until a specific number on the numerical markings 141 aligns with a particular location on the outer surface of the mandibular portion 120, this number indicates the insertion length of the distance adjustment screw 140 through the screw hole 123 beyond the length of the plurality of posts 131. In other words, this specific number indicates the additional separation distance between the maxillary portion 110 and the mandibular portion 120 beyond the length of the plurality of posts 131, which is achieved by the pressure exerted by the distance adjustment screw 140 on the inner surface of the maxillary portion 110.

In this case, the numbers on each numerical marking 141 may be listed in increments corresponding to the distance between adjacent threads of the distance adjustment screw 140 (3 mm in FIG. 5). The first numerical markings 141a may display numbers 0, 3, 6, 9, indicating that the distance adjustment screw 140 has been advanced through the screw hole 123 by 0 mm, 3 mm, 6 mm, and 9 mm, respectively, thereby increasing the separation distance between the maxillary portion 110 and the mandibular portion 120 by those amounts beyond the length of the plurality of posts 131. The second numerical markings 141b may display numbers 1, 4, 7, indicating that the distance adjustment screw 140 has been advanced through the screw hole 123 by 1 mm, 4 mm, and 7 mm, respectively, thereby increasing the separation distance between the maxillary portion 110 and the mandibular portion 120 by those amounts beyond the length of the plurality of posts 131. The third numerical markings 141c may display numbers 2, 5, 8, indicating that the distance adjustment screw 140 has been advanced through the screw hole 123 by 2 mm, 5 mm, and 8 mm, respectively, thereby increasing the separation distance between the maxillary portion 110 and the mandibular portion 120 by those amounts beyond the length of the plurality of posts 131.

According to one embodiment, the maxillary portion 110 and the mandibular portion 120 of the tray 100 are connected to each other by the connecting portion 130, but they can be completely separated by an external force from the user. Specifically, the connecting portion 130 may include a plurality of posts 131 as previously described, and the maxillary portion 110 and mandibular portion 120 may be spaced apart by a distance corresponding to the length of the plurality of posts 131. In this case, the plurality of posts 131 can be separated from at least one of the maxillary portion 110 and the mandibular portion 120 by an external force from the user, and upon separation of the plurality of posts 131, the maxillary portion 110 and the mandibular portion 120 can be completely separated. After applying an impression material to the outer surfaces of the maxillary portion 110 and the mandibular portion 120 of the tray 100 and placing the tray 100 in the patient's mouth to obtain the maxillomandibular registration, the physician can apply an external force to separate the maxillary portion 110 and the mandibular portion 120, thereby detaching the plurality of posts 131 from at least one of the maxillary portion 110 and the mandibular portion 120. The separated maxillary portion 110 and mandibular portion 120 can then be used in the subsequent process of fabricating the denture.

According to one embodiment of the present invention, the maxillomandibular registration tray 100 can adjust the separation distance between the maxillary portion 110 and the mandibular portion 120 through the introduction of a screw through the screw hole 123. This adjustment in the separation distance between the maxillary portion 110 and the mandibular portion 120 can significantly improve the accuracy of maxillomandibular registration when obtaining the patient's intermaxillary relationship. Specifically, the maxillary portion 110 and the mandibular portion 120 of the tray 100 are connected by the connecting portion 130, enabling simultaneous maxillomandibular registration of the patient's upper and lower jaws. After separating the maxillary portion 110 and the mandibular portion 120 (i.e., removing the connecting portion 130), a screw can be inserted to precisely adjust the separation distance between them, thereby adjusting the vertical dimension of occlusion. Subsequently, a bite registration material can be applied to the space between the maxillary portion 110 and the mandibular portion 120, allowing a precise intermaxillary relationship to be obtained in a short period with just a single patient visit.

According to one embodiment, the plurality of posts 131 are cylindrical, and the diameter of the plurality of posts 131 may be 1 mm to 1.5 mm. Specifically, if the diameter of the plurality of posts 131 exceeds 1.5 mm, the plurality of posts 131 may not be easily separated from the maxillary portion 110 or the mandibular portion 120 by external forces, and complete separation of the maxillary portion 110 and the mandibular portion 120 may be difficult with normal human force. Furthermore, if the diameter of the plurality of posts 131 is less than 1 mm, when the patient bites down on the tray 100, the plurality of posts 131 may not withstand the pressure and may bend, causing the separation distance between the maxillary portion 110 and the mandibular portion 120 to become less than the length of the plurality of posts 131.

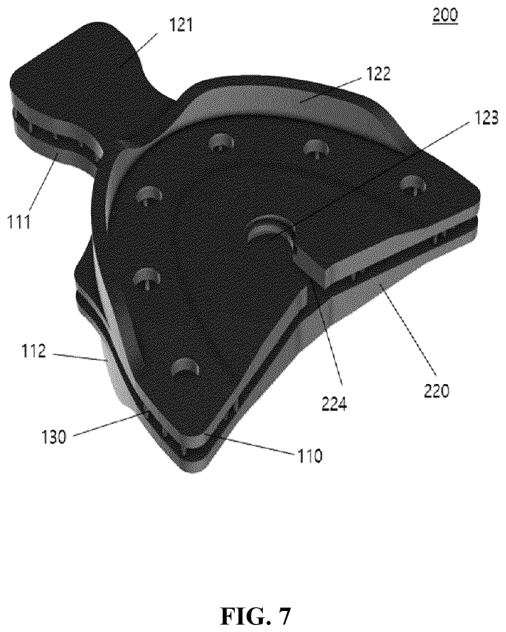

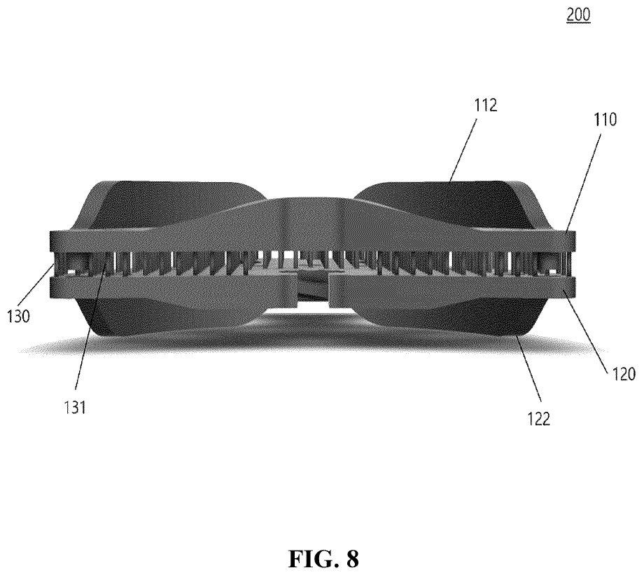

FIG. 7 illustrates a tray according to another embodiment of the present invention. FIG. 8 illustrates a tray according to another embodiment of the present invention.

Referring to FIGS. 7 and 8, the tray 200 according to another embodiment of the present invention may further include an extended passageway 224 extending from a surface of the screw hole 123 of the mandibular portion 220 to one edge of the mandibular portion 220 and penetrating an inner surface and an outer surface of the mandibular portion 220. Specifically, the passageway 224 may extend from a surface of the screw hole 123 of the mandibular portion 220 (the inner surface of the screw hole 123 having threads and grooves), and the passageway 224 may extend from the screw hole 123 to a corner of the mandibular portion 220 in a direction opposite to the direction in which the handle portion 111 is disposed. Accordingly, with the distance adjustment screw 140 introduced into the screw hole 123, the side of the distance adjustment screw 140 (specifically, the numerical markings 141) may be observed by the user from the corner side of the mandibular portion 220 through the slit-like passageway 224. Thus, by forming the passageway 224 extending from the screw hole 123 in the mandibular portion 220, a user who introduces the distance adjustment screw 140 into the screw hole 123 and adjusts the separation distance between the mandibular portion 220 and the maxillary portion 110 can easily see the numerical markings 141 of the distance adjustment screw 140 through the passageway 224. Accordingly, the degree of insertion of the distance adjustment screw 140 into the screw hole 123 can be more effectively and easily adjusted, and thus, the adjustment of the separation distance between the maxillary portion 110 and the mandibular portion 220 using the tray 200 can be performed more precisely and effectively. While the passageway 224 may be disposed in the mandibular portion 220, it is not limited thereto, and if the screw hole 123 is disposed in the maxillary portion 110, the passageway 224 may also be disposed in the maxillary portion 110 in which the screw hole 123 is formed.

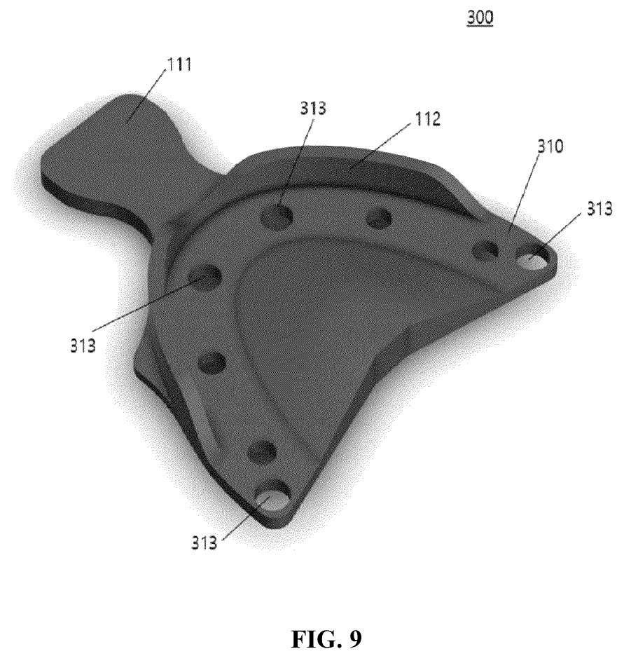

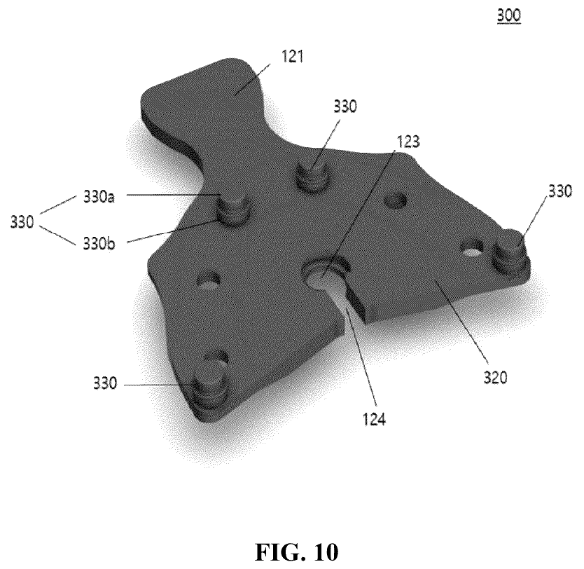

FIG. 9 is a drawing to illustrate a tray according to another embodiment of the present invention. FIG. 10 is a drawing to illustrate a tray according to another embodiment of the present invention.

Referring to FIGS. 9 and 10, the tray 300 according to another embodiment of the present invention may have the maxillary portion 310 and the mandibular portion 320 detachable from each other by the connecting portion 330. Specifically, the maxillary portion 310 and mandibular portion 320 can be moved between a disengaged and engaged state by the connecting portion 330. Referring to FIG. 10, the connecting portion 330 disposed on the mandibular portion 320 may include a gap portion 330b and an engagement portion 330a. The gap portion 330b may be a cylindrical structure that protrudes vertically from an inner surface of the mandibular portion 320 and may be configured to maintain a separation distance between the maxillary portion 310 and the mandibular portion 320 equal to the height of the gap portion 330b when the maxillary portion 310 and the mandibular portion 320 are connected to each other by the connecting portion 330. The engagement portion 330a of the connecting portion 330 may be a cylindrical structure that protrudes vertically from the upper surface of the gap portion 330b, and may be configured to insert into the engagement hole 313 of the maxillary portion 310 and engage with it to maintain the engaged state between the maxillary portion 310 and the mandibular portion 320. The engagement portion 330a may be cylindrical, and the diameter of the gap portion 330b may be larger than the diameter of the engagement portion 330a. Referring to FIG. 9, the maxillary portion 310 may have engagement holes 313 formed corresponding to the shape of the engagement portion 330a of the connecting portion 330, into which the engagement portion 330a can be inserted and engaged. The location and number of the engagement holes 313 may correspond to the location and number of the connecting portions 330 protruding from the inner surface of the mandibular portion 320. The connecting portion 330 protruding from the inner surface of the mandibular portion 320 and the engagement holes 313 formed in the maxillary portion 310 can be engaged with each other, allowing the maxillary portion 310 and the mandibular portion 320 to face each other's inner surfaces while maintaining a separation distance equal to the height of the gap portion 330b of the connecting portion 330. Furthermore, an external force may disengage the connecting portion 330 from the engagement hole 313 of the maxillary portion 310, separating the maxillary portion 310 and the mandibular portion 320. Of course, the engagement portion 330a and the gap portion 330b may be formed in various columnar shapes rather than cylindrical. Thus, the maxillary portion 310 and the mandibular portion 320 can transition between engaged and disengaged states through the engagement holes 313 formed in the maxillary portion 310 and the connecting portion 330 protruding from the mandibular portion 320, enabling a more efficient denture fabrication process.

According to another embodiment of the present invention, the tray may further include additional handles in addition to the handle portion 111. Specifically, referring to FIGS. 7 to 10, additional handles may be disposed on each side of the maxillary portion 110 and the mandibular portion 120. These additional handles protrude from the sides of the maxillary portion 110 and the mandibular portion 120 along a straight line that is perpendicular to the line connecting the handle portion 111 and the distance adjustment screw 140, and horizontal to the extension plane of the tray. This allows the user to grasp the maxillary portion 110 and the mandibular portion 120 with their hands. The additional handles may be formed adjacent to the end of the spaced apart stopper 112, rather than adjacent to the handle portion 111. The additional handles may be formed on at least one of the mandibular portion 120 and the maxillary portion 110. By including these additional handles, the tray enables users to effectively move and adjust the maxillary portion 110 and the mandibular portion 120 during maxillomandibular registration and denture fabrication.

Of course, various embodiments of the present invention may be combined with each other to form new embodiments. Specifically, a tray according to various embodiments of the present invention may include both the plurality of posts 131 in various shapes according to various embodiments of FIGS. 1 to 4 and 6, and the engagement portion 330a and gap portion 330b of FIGS. 9 and 10. Alternatively, it may include a mandibular portion 120 without the passageway 224, similar to the mandibular portion 120 of FIGS. 1 to 5, where the passageway 224 is excluded from the tray 300 of FIGS. 9 and 10. Naturally, the various technical features of the present invention can be independently combined in various ways.

A tray according to various embodiments of the present invention includes a maxillary portion capable of contacting the patient's maxilla, a mandibular portion capable of contacting the patient's mandible, and a connecting portion connecting between the inner surface of the maxillary portion and the inner surface of the mandibular portion, wherein the separation distance between the maxillary portion and the mandibular portion may be adjustable.

According to another feature of the present invention, one of the maxillary portion and the mandibular portion may include a screw hole formed in a center portion, and the tray may further include a distance adjustment screw that can be inserted into the screw hole.

According to another feature of the present invention, the distance adjustment screw may exert pressure on the inner surface of the other one of the maxillary portion and the mandibular portion as it is advanced into the screw hole.

According to another feature of the present invention, the separation distance between the maxillary portion and the mandibular portion can be adjusted according to the insertion distance of the distance adjustment screw into the screw hole.

According to another feature of the present invention, the distance adjustment screw may include one or more numerical markings extending in the longitudinal direction on the surface of the distance adjustment screw.

According to another feature of the present invention, the tray may further include a passageway extending from the surface of the screw hole to an edge of one of the maxillary portion and the mandibular portion.

According to another feature of the present invention, the maxillary portion and the mandibular portion may be completely separated from each other by an external force.

According to another feature of the present invention, the connecting portion may include a plurality of posts that connect and extend between the inner surface of the maxillary portion and the inner surface of the mandibular portion.

According to another feature of the present invention, the plurality of posts may be separated from at least one of the maxillary portion and the mandibular portion by an external force that separates the maxillary portion and the mandibular portion from each other.

According to another feature of the present invention, the inner surface of the maxillary portion and the inner surface of the mandibular portion include a region adjacent to the screw hole and a remaining region excluding the adjacent region, and the plurality of posts may be disposed only in the remaining region excluding the adjacent region.

According to another feature of the present invention, the maxillary portion and the mandibular portion may be detachable from each other by the connecting portion.

According to another feature of the present invention, the connecting portion may include a gap portion protruding from an inner surface of one of the maxillary portion and the mandibular portion, and an engagement portion further protruding from the gap portion, wherein the diameter of the gap portion is larger than the diameter of the engagement portion, and the other one of the maxillary portion and the mandibular portion includes an engagement hole into which the engagement portion can be inserted.

Although the present invention has been described with specific components and illustrated through limited embodiments and drawings to help provide a more comprehensive understanding, the invention is not limited to these embodiments. Those skilled in the art to which the invention pertains may make various modifications and variations based on this disclosure.

Accordingly, the idea of the invention is not to be limited to the embodiments described above, and it will be understood that the following claims, as well as all equally or equivalently modified variations thereof, fall within the scope of the idea of the invention.

Embodiments of the present invention have been described in more detail with reference to the accompanying drawings, but the invention is not necessarily limited to these embodiments and may be practiced in various modifications without departing from the technical ideas of the invention. Accordingly, the embodiments disclosed herein are intended to illustrate and not to limit the technical ideas of the invention, and the scope of the technical ideas of the invention is not limited by these embodiments. Therefore, the embodiments described above are exemplary in all respects and should be understood as non-limiting. The scope of protection of the present invention shall be construed in accordance with the following claims, and all technical ideas within the scope thereof shall be construed as falling within the scope of the present invention.

### EXPLANATION OF SYMBOLS

100, 200, 300: maxillomandibular registration tray
110, 310: maxillary portion
111: handle portion
112: stopper
120, 220, 320: mandibular portion
121: handle portion
122: stopper
123: screw hole
130, 330: connecting portion
131: posts
140: distance adjustment screw
141: numerical marking
141a: first numerical markings
141b: second numerical markings
141c: third numerical markings
124, 224: passageway
313: engagement hole
330a: engagement portion
330b: gap portion
A1: first region
A2: second region
A3: third region
A4: fourth region
A5: fifth region
L1: first distance
L2: second distance
L3: third distance

What is claimed is:

1. A maxillomandibular registration tray, comprising:
a maxillary portion configured to contact a patient's maxilla;
a mandibular portion configured to contact a patient's mandible; and
a connecting portion interconnecting an inner surface of the maxillary portion and an inner surface of the mandibular portion,
wherein separation distance between the maxillary portion and the mandibular portion is adjustable.

2. The tray of claim 1, wherein one of the maxillary portion and the mandibular portion includes a screw hole formed in a central portion of said one of the maxillary portion and the mandibular portion, and the tray further includes a distance adjustment screw configured to be inserted into the screw hole.

3. The tray of claim 2, wherein the distance adjustment screw applies pressure to the inner surface of the other of said one of the maxillary portion and mandibular portion as the distance adjustment screw is inserted into the screw hole.

4. The tray of claim 2, wherein the separation distance between the maxillary portion and the mandibular portion is according to an insertion distance of the distance adjustment screw into the screw hole.

5. The tray of claim 2, wherein the distance adjustment screw includes one or more numerical markings extending longitudinally along the surface of the distance adjustment screw.

6. The tray of claim 2, further comprising a passageway extending from the surface of the screw hole to an edge of said one of the maxillary portion and mandibular portion.

7. The tray of claim 1, wherein the maxillary portion and mandibular portion are completely separable from each other by external forces.

8. The tray of claim 1, wherein the connecting portion includes a plurality of posts and wherein the plurality of posts connect the inner surface of the maxillary portion and the inner surface of the mandibular portion.

9. The tray of claim 8, wherein the plurality of posts are detachable from at least one of the maxillary portion and mandibular portion by an external force separating the maxillary portion and the mandibular portion.

10. The tray of claim 8, wherein the inner surfaces of the maxillary portion and mandibular portion include a first region adjacent to the screw hole and a second region excluding the first region, and wherein the plurality of posts are disposed only in the second region.

11. The tray of claim 1, wherein the maxillary portion and mandibular portion are detachably connected to each other by the connecting portion.

12. The tray of claim 11, wherein the connecting portion includes a gap portion protruding from the inner surface of one of the maxillary portion and mandibular portion, and an engagement portion protruding further from the gap portion,
wherein the diameter of the gap portion is larger than the diameter of the engagement portion, and wherein the other one of the maxillary portion and mandibular portion includes an engagement hole into which the engagement portion is insertable.
